(19) United States
(12) Patent Application Publication
(10) Pub. No.: US 2025/0037205 A1
(43) Pub. Date: Jan. 30, 2025

(54) INDEX FORMULATION WITH ANOMALY DETECTION AND CORRECTION IN PROCUREMENT SYSTEMS

(71) Applicant: 3M INNOVATIVE PROPERTIES COMPANY, St. Paul, MN (US)

(72) Inventors: Yera Hakobyan, Shoreview, MN (US); lan S. Remming, St. Paul, MN (US)

(21) Appl. No.: 18/709,421

(22) PCT Filed: Nov. 17, 2022
(86) PCT No.: PCT/IB2022/061093

§ 371 Date: May 10, 2024

Related U.S. Application Data
(60) Provisional application No. 63/381,214, filed on Oct. 27, 2022.
(60) Provisional application No. 63/264,299, filed on Nov. 19, 2021.

(51) Int. Cl. G06Q 40/06

(52) U.S. Cl. CPC G06Q 40/06

(57) ABSTRACT

A system configured to generate purchase price indices (PPIs) for various uses including anomaly detection techniques is described. The system includes a memory configured to store purchasing transaction data for an organization, one or more portfolio components associated with the purchasing transaction data, and one or more external indices. The system includes processing circuitry being configured to select one or more of the portfolio components stored to the memory to form a candidate portfolio, to determine a reference quantity and a reference spend associated with the candidate portfolio based on portions of the purchasing transaction data that are associated with the one or more portfolio components included in the candidate portfolio, to generate a monthly adjusted portfolio spend for the candidate portfolio, to normalize the monthly adjusted portfolio spend to form an internal index associated with the candidate portfolio, and to store the internal index to the memory.

### TECHNICAL FIELD

This disclosure relates to the configuration of computer systems for price indexing and automatic anomaly detecting and correction of anomalous indices.

### BACKGROUND

Pricing and spend metrics (or indices) exist for many businesses and other entities that rely on the procurement (or “sourcing”) of goods or services to generate their own deliverables. For example, a manufacturing-oriented business may rely on the procurement of various raw materials to manufacture the finished product(s) that support the business's revenue generation. With manufacturing operations becoming larger-scale and more complex, there is a need for systems that can produce more accurate and reliable data (e.g., with respect to pricing and spend data) while simultaneously providing that data more quickly to effectuate better strategic planning.

### SUMMARY

Systems of this disclosure are configured to generate pricing information in the form of one or more purchase price indices (PPIs) using company-internal spend data, company-proprietary price indices, and publicly available price indices. The systems of this disclosure are configured to execute a multi-step algorithm that includes index portfolio selection, portfolio anomaly detection, and index calculation.

In one example, a system includes a memory, processing circuitry communicatively coupled to the memory, and an interface. The memory is configured to store purchasing transaction data for an organization, one or more portfolio components associated with the purchasing transaction data, and one or more external indices. The processing circuitry is configured to select one or more of the portfolio components stored to the memory to form a candidate portfolio, to determine a reference quantity and a reference spend associated with the candidate portfolio based on portions of the purchasing transaction data stored to the memory that are associated with the one or more portfolio components included in the candidate portfolio, and to generate a monthly adjusted portfolio spend for the candidate portfolio. The processing circuitry is further configured to normalize the monthly adjusted portfolio spend to form an internal index associated with the candidate portfolio, and to store the internal index to the memory. The interface is configured to output comparative data between the internal index and a corresponding external index selected from the one or more external indices stored to the memory.

In another example, a method includes storing, to a memory of a system, purchasing transaction data for an organization, one or more portfolio components associated with the purchasing transaction data, and one or more external indices. The method further includes selecting, by processing circuitry of the system, one or more of the portfolio components stored to the memory to form a candidate portfolio. The method further includes determining, by the processing circuitry, a reference quantity and a reference spend associated with the candidate portfolio based on portions of the purchasing transaction data that are associated with the one or more portfolio components included in the candidate portfolio. The method further generating, by the processing circuitry, a monthly adjusted portfolio spend for the candidate portfolio, and normalizing, by the processing circuitry, the monthly adjusted portfolio spend to form an internal index associated with the candidate portfolio. The method further includes storing, by the processing circuitry, the internal index to the memory, and outputting, by the processing circuitry, via an interface of the system, comparative data between the internal index and a corresponding external index selected from the one or more external indices stored to the memory.

In another example, an apparatus includes means for storing purchasing transaction data for an organization, one or more portfolio components associated with the purchasing transaction data, and one or more external indices, means for selecting one or more of the portfolio components to form a candidate portfolio, means for determining a reference quantity and a reference spend associated with the candidate portfolio based on portions of the purchasing transaction data that are associated with the one or more portfolio components included in the candidate portfolio, means for generating a monthly adjusted portfolio spend for the candidate portfolio, means for normalizing, the monthly adjusted portfolio spend to form an internal index associated with the candidate portfolio, means for storing the internal index; and means for outputting comparative data between the internal index and a corresponding external index selected from the one or more external indices

In another example, a non-transitory computer-readable storage medium is encoded with instructions that, when executed, cause processing circuitry of a computing device to: store, to the non-transitory computer-readable storage medium, purchasing transaction data for an organization, one or more portfolio components associated with the purchasing transaction data, and one or more external indices, to select one or more of the portfolio components to form a candidate portfolio, to determine a reference quantity and a reference spend associated with the candidate portfolio based on portions of the purchasing transaction data that are associated with the one or more portfolio components included in the candidate portfolio, to generate a monthly adjusted portfolio spend for the candidate portfolio, to normalize the monthly adjusted portfolio spend to form an internal index associated with the candidate portfolio, to store the internal index to the non-transitory computer-readable storage medium; and to output, via an interface of the computing device, comparative data between the internal index and a corresponding external index selected from the one or more external indices stored to the non-transitory computer-readable storage medium

Implementations of the subject matter described herein include computer-implemented methods that can be carried out by a system of one or more computers in one or more locations (e.g., via local computing, distributed computing, software as a service (SaaS), etc.) in various examples. The systems and techniques of this disclosure provide various technical improvements in the technical field of application computing. By implementing a pipelined process that incorporates index portfolio selection, portfolio anomaly detection, and index calculation, the systems of this disclosure provide enhanced data precision. That is, the pipelined processes that the systems of this disclosure implement at runtime generate more accurate PPIs without requiring the addition of computing overhead to deliver the enhanced data precision.

The details of various implementations of the subject matter described in this specification are set forth in the accompanying drawings and the description below. Other features, aspects, and advantages of the subject matter will be apparent from the description, the drawings, and the claims.

### BRIEF DESCRIPTION OF DRAWINGS

FIG. 1 is a block diagram illustrating an operating perspective of one example implementation of purchase price index (PPI) management system of this disclosure.

FIG. 2 is a data flow diagram (DFD) that illustrates an example workflow of this disclosure.

FIG. 3 illustrates examples of hierarchical layout data that an index constructor of this disclosure may use in constructing one or more of the auto-indices to be stored as an internal index of this disclosure.

FIG. 4 is a graph that illustrates a mapping of selected aspects of purchasing transaction data of this disclosure against an external index.

FIG. 5 illustrates a user interface (UI) that the PPI management system of FIG. 1 may output in accordance with one or more aspects of this disclosure.

FIG. 6 is a conceptual diagram showing if-else ladder that a portfolio constructor of this disclosure may implement to construct an initial portfolio (or “basket”) as part of the PPI generation techniques of this disclosure.

FIG. 7 is a flowchart illustrating an example process that the portfolio constructor of this disclosure may implement according to aspects of this disclosure.

FIG. 8 is a flowchart illustrating an example process which an anomaly detector of this disclosure may implement to perform anomaly detection and anomaly cleansing according to aspects of this disclosure.

FIG. 9 is a flowchart illustrating an example process that an index constructor of this disclosure may implement to form a PPI according to aspects of this disclosure.

### DETAILED DESCRIPTION

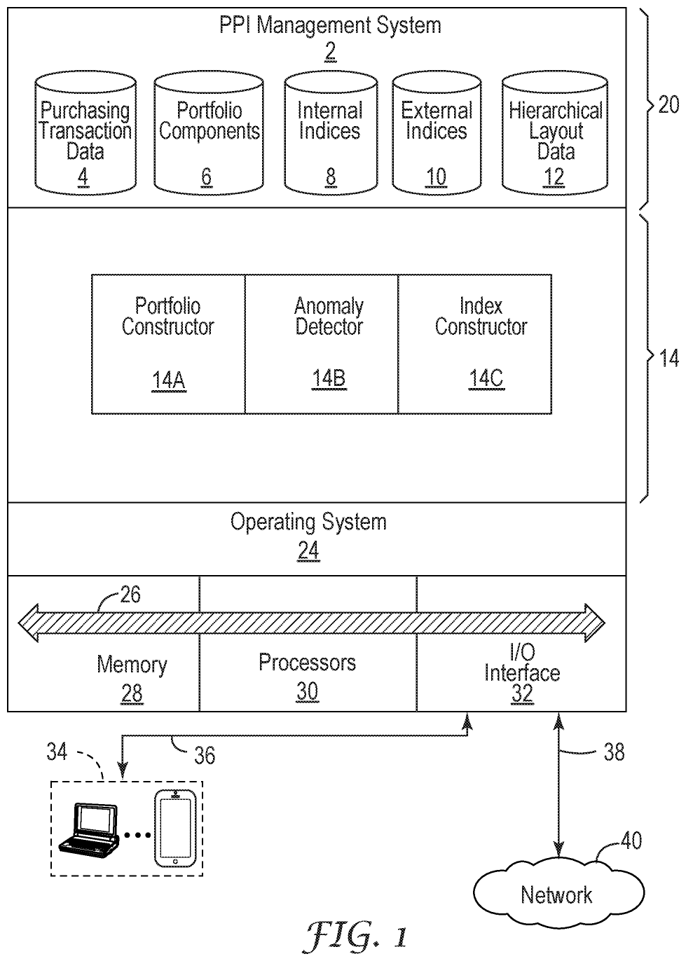

FIG. 1 is a block diagram illustrating an operating perspective of one example implementation of purchase price index (PPI) management system 2 of this disclosure. While FIG. 1 shows one implementation of PPI management system 2 that is consistent with aspects of this disclosure, it will be appreciated that other architectures (whether single-device or distributed architectures) of PPI management system 2 are consistent with aspects of this disclosure, as well.

In the example of FIG. 1, PPI management system 2 includes one or more processors 28 and memory 32. In some examples, memory 32 and processors 28 may be integrated into a single hardware unit, such as a system on a chip (SoC) or integrated circuit (IC). Each of processors 28 may comprise one or more of a multi-core processor, a controller, a digital signal processor (DSP), an application specific integrated circuit (ASIC), a field-programmable gate array (FPGA), processing circuitry (e.g., fixed function circuitry, programmable circuitry, or any combination of fixed function circuitry and programmable circuitry) or equivalent discrete logic circuitry or integrated logic circuitry. Memory 32 may include any form of memory for storing data and executable software instructions, such as random-access memory (RAM), read-only memory (ROM), programmable read only memory (PROM), erasable programmable read-only memory (EPROM), electronically erasable programmable read only memory (EEPROM), and flash memory.

Memory 32 and processor(s) 28 provide a computer platform for executing operation system 24. In turn, operating system 24 provides a multitasking operating environment for executing one or more software components 14. As shown, processors 28 connect via an input/output (I/O) interface 32 to external systems and devices via network 40. I/interface 32 may incorporate network interface hardware, such as one or more wired and/or wireless network interface controllers (NICs) for communicating via communications links 36 and 38. In the particular example of FIG. 1, communications link 38 represents one or more network-enabled communicative connections, such as a link to one or more packet-switched networks collectively illustrated as network 40. Network 40 may represent any of a data-enabled telephony network (such as a cellular data network), a wide-area network (such as the Internet), a public network (such as the Internet), a private network, such as a local-area network (LAN) and/or an enterprise network, or any other type of network that enables data communications, or any combination of any two or more of the networks listed above.

Communications link 38, which communicatively couples PPI management system 2 to network 40 and to other remote devices via network 40, may include one or more wired connections (e.g., an Ethernet® connection), wireless connections (e.g., a Wi-Fi™ connection) or a combination of both wired and wireless communicative connections. In the example illustrated in FIG. 1, I/O interface 32 also facilitates communication between PPI management system 2 and one or more remote devices 34 via communications link 36. In the particular example of FIG. 1, communications link 36 represents one or more local connections, such as a connection to remote devices 34 via a local area network (LAN) and/or personal area network (PAN) connections, such as one or more of near-field communication (NFC) pairings, Bluetooth® pairings, Zigbee® pairings, or the like.

Bus 26 provides inter-component connectivity between processors 28, memory 32, and I/O interface 32 in the implementation shown in FIG. 1. Bus 26 may represent a half-duplex or full-duplex bus that provides data transfer capabilities between two or more of processors 28, memory 32, I/O interface 32, and/or any other hardware components of PPI management system 2. Bus 26 may represent a system bus or a computer bus of various types, including one or more bus networks. Regardless of the topology implemented, bus 26 may, in various examples, incorporate various types of inter-component connectivity hardware such as those conforming to any of first generation, second generation, third generation, or fourth generation bus or bus network technology as set forth by the Institute of Electrical and Electronics Engineers (IEEE), and/or other bus or bus network technologies defined in developing or later-adopted standards.

Software components 14 of PPI management system 2, in the particular example of FIG. 1, include portfolio constructor 14A, anomaly detector 14B, and index constructor 14C. In some example approaches, one or more of software components 14 represent executable software instructions that may take the form of one or more software applications, software packages, software libraries, hardware drivers, and/or Application Program Interfaces (APIs). Moreover, any of software components 14 may, when executed, cause PPIMS 2 to output data and/or receive data via I/O interface 32.

Aspects of memory 32 that provide non-volatile storage and/or long-term storage support local storage of data repositories 20. In the example of FIG. 1, data repositories 20 include purchasing transaction data 4, portfolio components 6, internal indices 8, external indices 10, and hierarchical layout data 12. One or more of software components 14 may invoke processors 28 and memory 32 to access one or more of data repositories 20 to retrieve data for various purposes, such as to construct a portfolio of previously purchased goods and/or goods to be purchased in the future, to detect anomalies relating to prices and/or quantities, and for index construction with respect to the constructed portfolio. In some examples, software components 14 may implement read/write capabilities with respect to data repositories 20, such as to access and use information available from data repositories 20 and/or to modify information currently stored to data repositories 20. In implementations in which PPI management system 2 represents a distributed computing system, one or more of data repositories 20 may be positioned at a remote location from processors 28, and software components 14 may, in these implementations, access data repositories 20 using NIC hardware of I/O interface 32.

In an example in which PPI management system 2 is operated by an entity that is engaged in manufacturing, portfolio constructor 14A may access purchasing transaction data 4 to obtain spend data and may access portfolio components 6 to obtain material identifiers associated with the spend data to preprocess data to be represented in a PPI. Portfolio constructor 14A may execute a portfolio selection algorithm that categorizes the material identifiers obtained from portfolio components 6. For example, portfolio constructor 14A may categorize the material identifiers into groups based on priority scores calculated using historical purchasing consistency obtained from transactions stored to purchasing transaction data 4 that correspond to the material identifiers. Portfolio constructor 14A assigns higher priority scores to material identifiers included in portfolio components 6 that are purchased more consistently on year-to-year basis, and assigns lower priority scores to material identifiers that, according to purchasing transaction data 4, are purchased less consistently on a year-to-year basis. In this manner, portfolio constructor 14A implements techniques of this disclosure to enable more accurate pricing estimates for the PPI being constructed by prioritizing materials with more complete transactional coverage in purchasing transaction data 4. The portfolio selection algorithm executed by portfolio constructor 14A returns the highest priority group that satisfies the one or more predetermined criteria for inclusion in a PPI portfolio.

Anomaly detector 14B performs techniques of this disclosure to detect anomalies in the past transactions obtained from purchasing transaction data 4 for the material identifiers selected from portfolio components 6 for the PPI portfolio. Anomaly detector 14B cleanses the initial transaction dataset on a per-material basis to remove adjustment transactions. Additionally, anomaly detector 14B identifies anomalies based on price and quantity features using k-means clustering and removes these anomalies from PPI consideration. In some examples, anomaly detector 14B may also identify purely price-based anomalies by executing one or more forecasting algorithms and may remove these anomalies from PPI consideration as well.

Index constructor 14C uses the anomaly-cleansed portfolio generated by portfolio constructor 14A and anomaly detector 14B as input parameters to generate one or more purchase price auto-indices according to aspects of this disclosure. As used herein, “purchase price auto-indices” are standardized time series based on purchasing transactions that capture and represent price inflation and deflation trends for sub-entities and spend hierarchies in the organization that manages PPI management system 2. To construct auto-indices according to aspects of this disclosure, index constructor 14C uses portions of hierarchical layout data 12, such as business group, division, and profit center (within the organization controlling PPI management system 2) that are associated with the material identifiers preliminarily selected by portfolio constructor 14A.

Index constructor 14C may also use data available from one or both of portfolio components 6 and/or purchasing transaction data 4 to construct auto-indices based on one or more of purchasing category, vendor identifiers, or material group in the auto-index formulation. Index constructor 14C may divide each auto-index generated in this way based on geographical demarcations. In turn, index constructor 14C may store, to internal indices 8, the auto-indices generated in this way and divided based on geographical information.

PPI management system 2 may enable the organization that controls PPI management system 2 to use internal indices 8 to derive comparative data, and to implement one or more decisions based on the comparative data. As one example, PPI management system 2 may provide comparative data between internal inflation/deflation trends for procured goods/services across geographies and/or across organizational hierarchies and spend hierarchies. As another example, PPI management system 2 may provide comparative data on inflation/deflation trends by comparing one or more of internal indices 8 against one or more of external indices 10.

For example, the organization that controls PPI management system 2 may invoke functionalities of PPI management system 2 to select particular indices of external indices 10 that correlate to material identifier groupings of certain auto-indices stored to internal indices 8, and compare these corresponding sets of indices selected from external indices 10 and internal indices 8 to derive inflation/deflation trend information. The organization that controls PPI management system 2 use the auto-indices saved to internal indices 8 and/or the inflation/deflation information derived therefrom to inform purchasing decisions and/or to inform vendor negotiations.

PPI can help with various types of analysis, including spend planning for organizations. As one example of this, if PPI management system 2 outputs information indicating an increasing purchase volume combined with non-negative per-unit cost, the organization may use this information to identify a price negotiation opportunity (PNO). As another example, if PPI management system 2 outputs information indicating non-negative purchasing volume of a non-perishable material or material grouping combined with a negative price trend, the organization may use this trend information to identify an opportunity to increase purchasing volume for storage and future use.

In some examples, PPI management system 2 may output data directly to users in a human-interpretable and/or machine-readable format, such as via display hardware, audio output hardware, etc. In other examples, PPI management system 2 may output data via other computing devices that are communicatively coupled to PPI management system 2, such as via remote devices 34 using communications link 36 and/or via other computing devices that are communicatively coupled to I/O interface 32 over network 40 by way of communications link 38. In this way, PPI management system 2 may provide PNO information or purchasing guidance both to local users as well as to remote users. In some examples, PPI management system 2 may authenticate the requesting device(s) using authentication information received from the requesting device(s), or may authenticate requesting device(s) automatically if the such device(s) are connected over a LAN, a PAN, or a virtual private network (VPN) tunnel. For instance, PPI management system 2 may, pending certain conditions being met, automatically authenticate devices that are communicatively coupled to PPI management system 2 though a VPN tunnel implemented via network 40.

In this way, PPI management system 2 implements techniques of this disclosure to aggregate and analyze past procurement information and pricing information to generate auto-indices that can be used to guide purchasing decisions and/or to identify PNOs. By constructing the auto-indices of internal indices 8 and providing comparative data between internal indices 8 and external indices 10, PPI management system 2 provides one or more technical improvements in the technical field of application computing. For example, PPI management system 2 provides enhanced data precision by curating internal indices 8 using custom-constructed portfolios and cleansing the portfolios of various anomalies.

By generating and outputting comparative data between portfolio-corresponding auto-indices of internal indices 8 and external indices 10, PPI management system 2 provides enhanced precision with respect to data that can be used to inform PNO detection and purchasing decisions. PPI management system 2 provides these data precision enhancements in a scalable manner that can accommodate potentially large amounts of purchasing transaction data 4 and a wide variety of portfolio components 6, with high complexity of hierarchical layout data 12 as is common with large organizations. PPI management system 2 provides these data precision and scalability enhancements over existing systems.

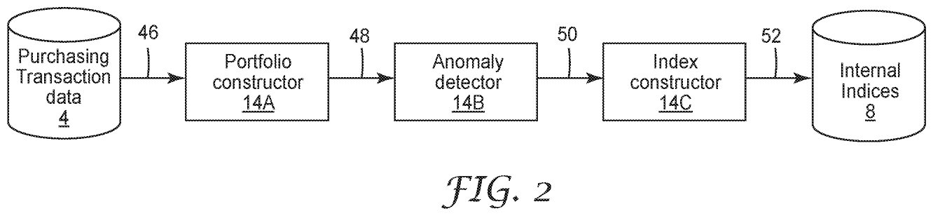

FIG. 2 is a data flow diagram (DFD) 44 that illustrates an example workflow of this disclosure. Software components of PPI management system 2 may implement the workflow of DFD 44 to generate one or more auto-indices to store to internal indices 8. For instance, portfolio constructor 14A may retrieve relevant portions of purchasing transaction data 4 to form a portfolio that is relevant to an auto-index that is currently being constructed (step 46). Anomaly detector 14B may cleanse the portfolio-related information of purely price-related and/or quantity-related anomalies by executing one or more techniques, such as k-means clustering and/or a forecasting algorithm (step 48). Index constructor 14C may generate an organization-internal auto-index the selected and anomaly-cleansed portfolio using the anomaly-cleansed portfolio data (obtained at step 50). In turn, index constructor 14C may store the newly constructed auto-index to internal indices 8 (step 52).

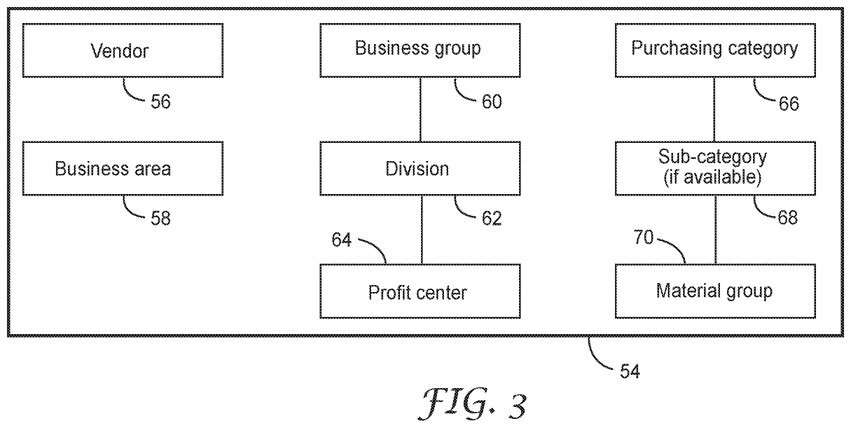

FIG. 3 illustrates examples of hierarchical layout data 12 that index constructor 14C may use in constructing one or more of the auto-indices to be stored to internal indices 8. The subset hierarchical layout data 12 shown in FIG. 3 (and referred to herein as hierarchical division data 54) incorporate organizational hierarchy information, geographical demarcation data, and material category information. Again, while use case examples (such as hierarchical division data 54 of FIG. 3) are discussed with respect to material procurement in the context of manufacturing, it will be appreciated that the systems of this disclosure can also be used in the context of other types of procurement and for other types of industries as well.

In some examples, index constructor 14C may parse one or more of internal indices 8 based on one or more examples of hierarchical division data 54. As one example, index constructor 14C may parse internal indices 8 based on vendor data 56. As another example, index constructor 14C may parse internal indices 8 based on geographical information, such as business area data 58. As another example still, index constructor 14C may parse internal indices 8 based on organizational hierarchy information, such as business group 60, division 62, and/or profit center 64. As another example still, index constructor 14C may parse internal indices 8 based on material classification information, such as one or more of purchasing category 66, sub-category 68 (if available), and/or material group information 70.

In this way, PPI management system 2 provides enhanced data precision with respect to generating internal indices 8. By parsing the generated auto-indices using one or more of the classification criteria included in hierarchical division data 54, PPI management system 2 implements techniques of this disclosure to generate internal indices 8 with granularity and applicability appropriate for particular scenarios. For example, by parsing internal indices 8 based on geographic demarcations available via business area data 58, PPI management system 2 may provide auto-indices that guide purchasing decisions and PNO identification in a manner that is suited to the geographic location of the future purchase or the past purchase with a negotiable price.

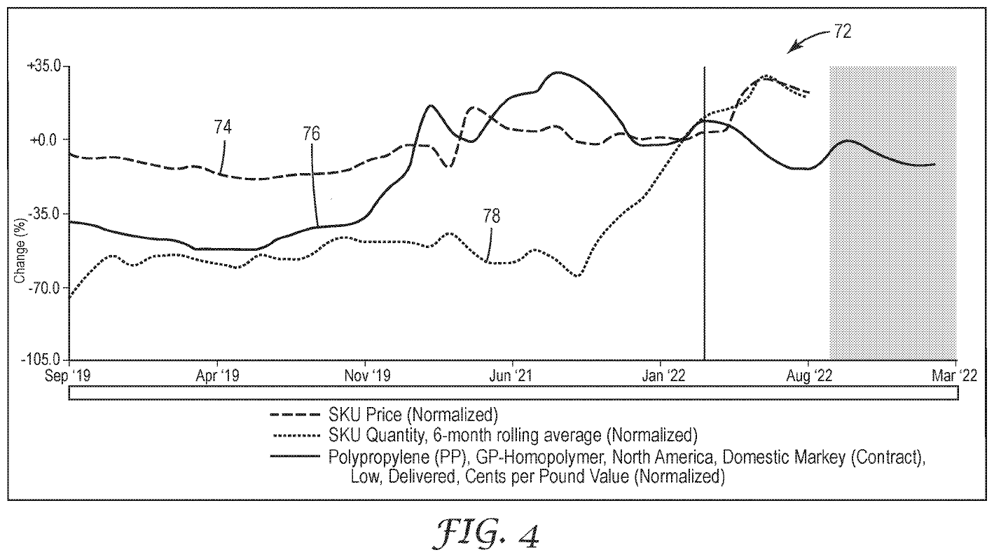

FIG. 4 is a graph 72 that illustrates a mapping of selected aspects show in FIG. 1, such as purchasing transaction data 4 against one of external indices 10. Graph 72 shows the unit price paid for a material on price plot 74 and a purchased quantity (normalized as a six-month rolling average) on purchased quantity plot 76. Graph 72 also shows, on external price index plot 78, one of external indices 10 that is correlated to the material (or material group) associated with price plot 74 and purchased quantity plot 76. In some examples, external price index plot 78 may reflect one of external indices 10 that directly tracks the material or material group associated with price plot 74 and purchased quantity plot 76. In other examples, external price index plot 78 may reflect one of external indices 10 that tracks a material or material group that is related to the material or material group associated with price plot 74 and purchased quantity plot 76 (e.g., a raw material used to manufacture the material/material group associated with price plot 74 and purchased quantity plot 76, a direct or indirect derivative of the material/material group associated with price plot 74 and purchased quantity plot 76, etc.).

PPI management system 2 may generate graph 72 as a visual output via display hardware that is either part of PPI management system 2 or is communicatively coupled to PPI management system 2, such as by way of remote devices 34 or over network 40. In some examples, PPI management system 2 may include graph 72 as part of an interactive graphical user interface (GUI). In some such examples, PPI management system 2 may generate graph 72 based on input received via I/O interface 32, such as user input specifying the material/material group associated with price plot 74 and purchased quantity plot 76, or input specifying the one of external indices 10 to plot on external price index plot 78, or both.

By generating graph 72 and rendering graph 72 for display, PPI management system 2 enables users to view and analyze comparative data between past purchase information of a material (in the form of price paid and quantity purchased) and pertinent ones of external indices 10. PPI management system 2 may normalize the units of price plot 74, purchase quantity plot 76, and external price index plot 78. In this way, PPI management system 2 improves the data precision of the comparative data generated and output by way of graph 72. In various examples, PPI management system 2 may attenuate the time span shown by the horizontal (X) axis of graph 72 based on user input received via I/O interface 32 or based on other criteria.

Graph 72 is an example of comparative data generated by PPI management system 2 that can be used to identify PNO scenarios or to inform purchasing decisions. As one example, starting from reference month 80, a flat or upward trend in the price plot 74 combined with an upward trend in the purchased quantity plot 76 may indicate a possible PNO. As another example, starting from reference month 80, a flat or upward trend in the price plot 74 combined with a descending trend in the external index plot 78 may indicate a possible PNO.

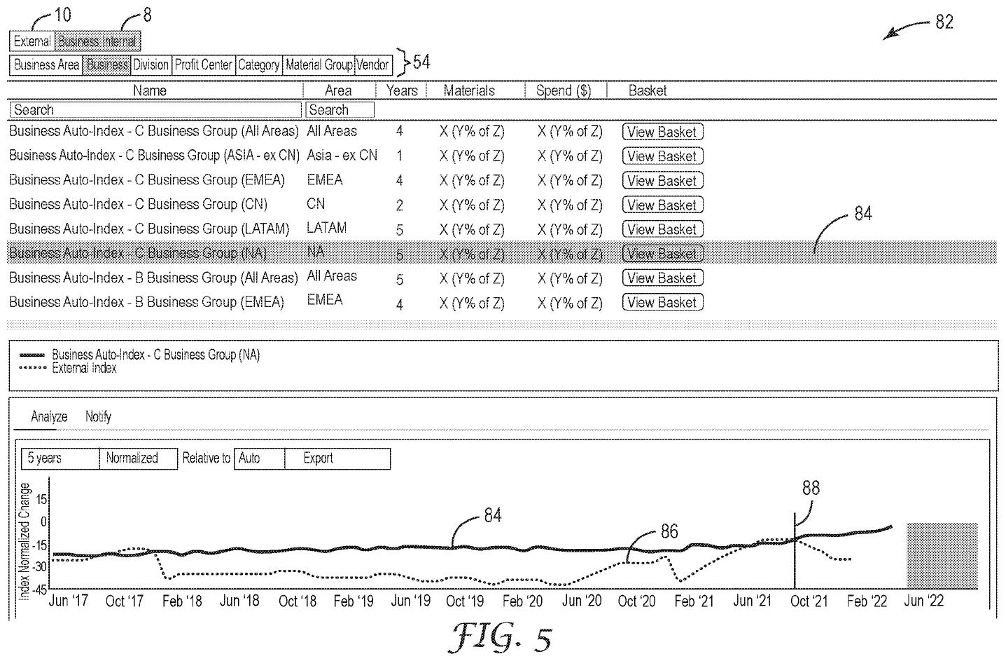

FIG. 5 illustrates a user interface (UI) 82 that PPI management system 2 may output in accordance with one or more aspects of this disclosure. As in the case of graph 72 shown in FIG. 4, PPI management system 2 may generate UI 82 as a visual output via display hardware that is either part of PPI management system 2 or is communicatively coupled to PPI management system 2, such as by way of remote devices 34 or over network 40, and in some cases, using parameters specified in user input received via I/O interface 32. In the use case scenario described herein, PPI management system may receive, via I/O interface 32, user input(s) specifying one of one of internal indices 8 and a corresponding one of external indices 10.

PPI management system 2 may generate UI 82 to provide comparative data between the selected one of internal indices 8 (illustrated in FIG. 5 by way of internal index 84) and the corresponding one of external indices 10 (illustrated in FIG. 5 by way of external index 86). As shown in FIG. 5, PPI management system 2 may generate UI 82 to include toggleable options between a menu of external indices 10 and a menu of internal indices 8, and to include selectable UI elements corresponding to various elements of hierarchical division data 54 shown in FIG. 3.

In the particular use case scenario shown in FIG. 5, PPI management system 2 generates UI 82 to display comparative plots between internal index 84 and external 86 (normalized) over a rolling five-year period, although it should be appreciated that external index 86 may include information pertaining to a period that is longer than five years. UI 82 includes inflection point 88, which may represent a time at or near a PNO. More specifically, inflection point 88 shows a temporal intersection between an increase in the internal index 84 and a decrease in the external index 86. In this way, PPI management system 2 improves data precision in the technical field of application computing by generating internal indices 8 according to the techniques of this disclosure and providing output with comparative data between corresponding indices selected from internal indices 8 and external indices 10. In the use case scenario of UI 82, PPI management system 2 identifies or enables users to detect inflection point 88, thereby potentially triggering a price negotiation.

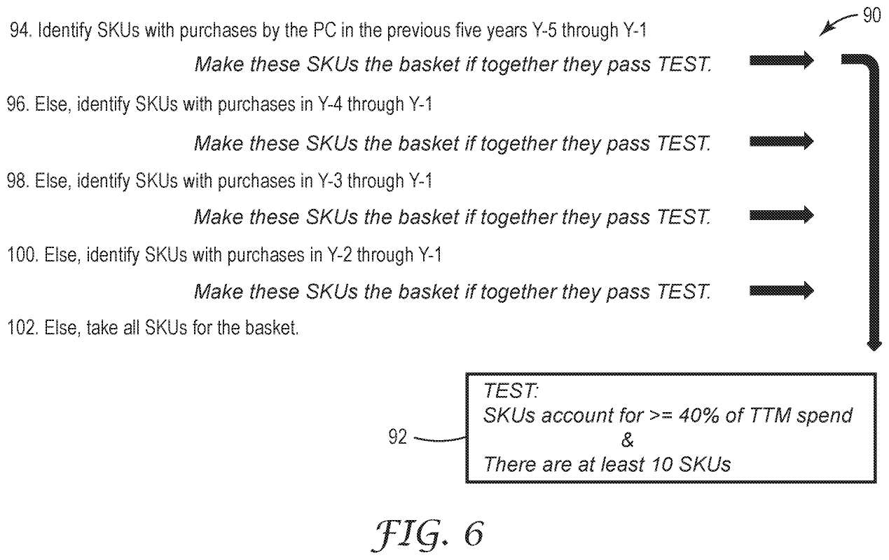

FIG. 6 is a conceptual diagram showing if-else ladder 90 that portfolio constructor 14A may implement to construct an initial portfolio (or “basket”) as part of the PPI generation techniques of this disclosure. The nested logic construct of if-else ladder 90 implements test 92 up to a maximum number of iterations, as needed. As part of test 92, portfolio constructor 14A determines whether a selection of portfolio components 6 meets two criteria, based on corresponding portions of purchasing transaction data 4. In the example of FIG. 6, portfolio constructor 14A uses stock keeping units (SKUs), or other unique identifiers, to identify individual entries in portfolio components 6. As the first criterion of test 92, portfolio constructor 14A determines whether the SKUs of the selected portfolio components 6 account for at least forty percent of the trailing twelve-month spend for the organization that controls PPI management system 2, or the relevant profit center or other sub-organization set forth in hierarchical division data 54. As the second criterion of test 92, portfolio constructor 14A determines whether the number of SKUs meeting the first criterion is at least ten.

At step 94 of if-else ladder 90, portfolio constructor 14A identifies those SKUs of portfolio components 6 that have been purchased (e.g., by the profit center or another sub-level of the organization, or by the organization at large) for each of the last five years, not including the current year (shown as a period from Y−5 or current year minus five through Y−1, or current year minus one, and where Y0 which denotes the current year). If the SKUs identified at step 94 as having been purchased in each of the last five years passes test 92 (by meeting both criteria of test 92), then portfolio constructor 14A constructs an initial “basket” using the SKUs identified at step 94. If portfolio constructor 14A fails to identify any SKUs at step 94 or if the identified SKUs fail test 92, then portfolio constructor 14A proceeds to step 96. At step 96, portfolio constructor 14A identifies those SKUs of portfolio components 6 that have been purchased for each of the last four years (shown as a period from Y−4 or current year minus four through Y−1, or current year minus one). If the SKUs identified at step 96 as having been purchased in each of the last four years passes test 92 (by meeting both criteria of test 92), then portfolio constructor 14A constructs an initial “basket” using the SKUs identified at step 96. If portfolio constructor 14A fails to identify any SKUs at step 96 or if the identified SKUs fail test 92, then portfolio constructor 14A proceeds to step 98.

At step 98, portfolio constructor 14A identifies those SKUs of portfolio components 6 that have been purchased for each of the last three years (shown as a period from Y−3 or current year minus three through Y−1, or current year minus one). If the SKUs identified at step 98 as having been purchased in each of the last three years passes test 92 (by meeting both criteria of test 92), then portfolio constructor 14A constructs an initial “basket” using the SKUs identified at step 98. If portfolio constructor 14A fails to identify any SKUs at step 98 or if the identified SKUs fail test 92, then portfolio constructor 14A proceeds to step 100. At step 100, portfolio constructor 14A identifies those SKUs of portfolio components 6 that have been purchased for each of the last two years (shown as a period from Y−2 or current year minus two and Y−1, or current year minus one). If the SKUs identified at step 100 as having been purchased in each of the last two years passes test 92 (by meeting both criteria of test 92), then portfolio constructor 14A constructs an initial “basket” using the SKUs identified at step 100. If portfolio constructor 14A fails to identify any SKUs at step 100 or if the identified SKUs fail test 92, then portfolio constructor 14A proceeds to step 102. Portfolio constructor 14A may execute step 102 as a default option. At step 102, portfolio constructor may construct the initial “basket” for the PPI using all SKUs of portfolio components 6 that are associated with the spending segment currently being indexed. Portfolio constructor 14A defaults to the basket described at step 102 in instances of insufficient spend and/or insufficient SKU count to form a suitable subset relying on consistent historical spend.

In general, FIG. 6 is described in relation to a moving five-year window, although as previously mentioned, systems and techniques described herein can use data in any number of time frames, such as a three-year window, ten-year window, and the like. As a result, specific use cases describing a certain period of time should not be considered limiting. Likewise, while specific implementations have been described omitting the current year from the analysis, it may be possible to use current year data as part of the technique described in FIG. 6.

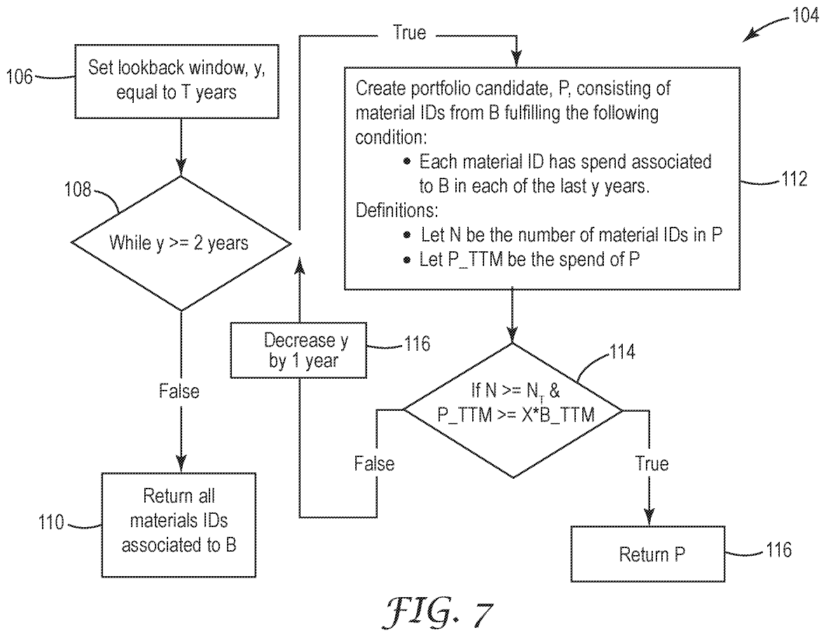

FIG. 7 is a flowchart illustrating an example process 104 that portfolio constructor 14A may implement according to aspects of this disclosure. Process 104 may begin with portfolio constructor 14A setting a lookback window (‘y’) to a value (‘T’) set in units of years (106). In some instances, as in the example described above with respect to FIG. 6, portfolio constructor 14A may initialize the value of ‘T’ at five. Portfolio constructor 14A may determine whether y is currently set to a value of at least two (decision block 108). Expressed in algorithmic terms, decision block 108 functions as a control flow statement, namely in this case, a while loop. The condition statement of decision block verifies whether or not the value of y is currently two or more. If portfolio constructor 14A determines that y is currently set to a value of at least two (‘TRUE’ branch of decision block 108), portfolio constructor 14A creates a candidate portfolio (or “basket”) ‘P’ from those material identifiers inside of ‘B’ that fulfill the condition of having spend associated with B in each of the last y years (112). ‘B’ denotes the collection of purchasing transactions (as obtained from purchasing transaction data 4) for the organizational segment (as defined by hierarchical division data 54) for which PPI management system 2 is currently indexing spend. As shown in FIG. 7, ‘N’ denotes the number of material identifiers in P, and ‘P_TTM’ denotes the trailing twelve-month spend for P.

Upon constructing candidate portfolio P, portfolio constructor 14A may enter decision block 114. At decision block 114, portfolio constructor 14A may determine whether facets of candidate portfolio P satisfy two conditions, namely, whether (1) P_TTM represents at least ‘X’ percent of the total TTM spend (B_TTM) for the segment currently being indexed; and (2) N (the number of material identifiers in P) is greater than or equal to N_{T} number of materials (where ‘N_{T}’ denotes a predetermined minimum allowable size for the portfolio for the index being constructed. ‘B_TTM’ denotes the trailing twelve-month (TIM) spend for B, and ‘X’ denotes a predetermined threshold fraction of B_TTM for the index portfolio under construction.

If portfolio constructor 14A determines that the candidate portfolio P satisfies both conditions examined for at decision block 114 (“TRUE” branch of decision block 114), then portfolio constructor 14A may return the candidate portfolio P as the portfolio for the index that PPI management system 2 is currently constructing (116). Otherwise, if portfolio constructor 14A determines that candidate portfolio P does not satisfy the set of conditions set forth at decision block 114 (“FALSE” branch of decision block 114), portfolio constructor 14A decrements y by one (1) year (118) and returns to decision block 108. As long as the value of y remains at or above two (“TRUE” branch of decision block 108), portfolio constructor may iteratively perform step 112, until successfully reaching step 116. If the recursive decrementing of y causes the value of y to fall below two (“FALSE” branch of decision block 108), portfolio constructor 14A may default to constructing P by including all material identifiers associated with B (110).

Given the spend data that will be represented in the index under construction, the portfolio selection algorithm represented by process 104 divides the associated material identifiers into groups categorized by priority and returns the highest priority group that satisfies the business-determined criteria for an index portfolio. Priority scores are based on the historical consistency of material purchasing transactions. Materials purchased consistently year-to-year receive higher priority scores than materials with less consistency. Priority is decided in this manner because materials with more complete transactional coverage enable more accurate pricing estimates for the index. The highest priority group formed by the portfolio selection algorithm represented by process 104 consists of the materials that have been purchased every completed year starting from year X, where year X is equal to the current year minus the lookback period. For example, given a date in the year 2021 and a lookback period of five years, the highest priority group consists of all the materials purchased in every completed year beginning with 2016.

Each subsequent lower priority group consists of materials with purchases in every completed year after the first year of the prior priority. The second to lowest priority group consists of all materials that have purchases in the prior two completed years. The lowest priority group consists of all materials. The reader should note that materials in higher priority groups are repeated in each lower priority group. This method of grouping results in a sequence of groups ordered by priority.

The portfolio selection algorithm of process 104 then identifies the first group that satisfies both of the following two criteria: (1) the group collectively accounts for at least X percent of the total TIM spend for the segment of data that is to be indexed; and (2) the group consists of at least NT materials. If every group fails to meet the criteria described above, the portfolio selection algorithm of process 104 returns the lowest priority group, which is the full set of materials associated with the hierarchical level for which the index is being generated.

Portfolio constructor 14A assigns a priority to the list of material identifiers returned by the portfolio selection algorithm of process 104 and associates the priority with the index. A high priority indicates a portfolio with materials that are consistently purchased year-over-year. In one example, an index priority of one (1) if the portfolio selection algorithm of process 104 returns the complete set of associated materials (by defaulting to step 110). Otherwise, the index priority is the priority of the group returned by the portfolio selection algorithm of process 104 (e.g., via a basket formed at step 116).

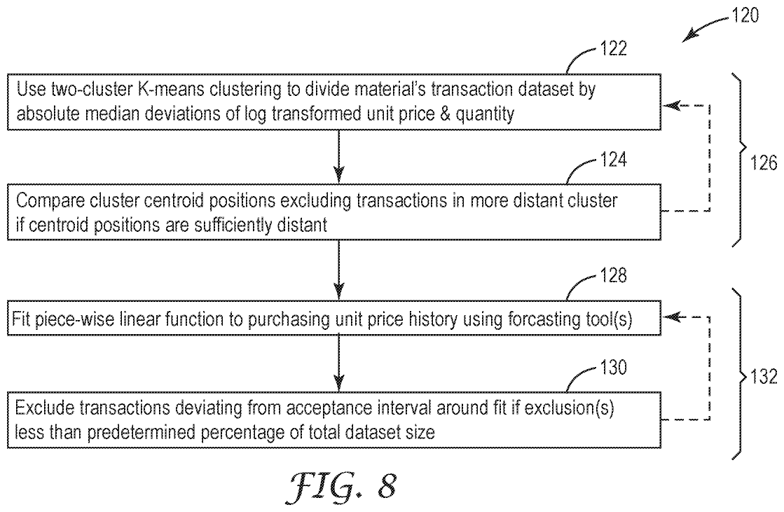

FIG. 8 is a flowchart illustrating process 120, which anomaly detector 14B may implement to perform anomaly detection and anomaly cleansing according to aspects of this disclosure. Anomaly detector 14B may execute process 120 to detect anomalies in and cleanse anomalies from the index portfolio generated by portfolio constructor 14A according to process 104 of FIG. 7. If anomaly detector 14B identifies or flags any transactions as anomalies using process 120, anomaly detector 14B may remove any transactions flagged in this way from the index calculation procedure.

As a preprocessing step to process 120, anomaly detector 14B may treat any adjustment transactions that may be present in the purchasing transaction datasets obtained from purchasing transaction data 4 (a preprocess referred to herein as “adjustment transaction treatment”). An example of a type of adjustment that anomaly detector 14B may treat as part of the adjustment transaction treatment preprocessing are transactions with non-positive spend and/or quantity, such as return transactions with negative spend and quantity. As part of the adjustment transaction treatment, anomaly detector 14B may first group each material's transactions by purchase order (PO) number. In turn, anomaly detector 14B may orders the positive spend and quantity transactions by the transactions' temporal proximity to the return transactions in the PO if any are present. According to the adjustment transaction treatment preprocessing, anomaly detector 14B may assign the last position to transaction(s) that are timestamped after the return. Anomaly detector 14B may identify the first transaction in the time-ordered list with offsetting spend and quantity to the return as a transaction that was resolved by issue of a return, and therefore exclude the transaction identified in this way from further calculations. As part of the adjustment transaction treatment preprocessing, anomaly detector 14B may then exclude all non-positive spend and/or quantity transactions from further calculations.

Process 120 is broadly classified into two phases, namely, a quantity/price anomaly exclusion phase 126 and a price anomaly exclusion phase 132. The quantity/price anomaly exclusion phase 126 may begin with anomaly detector 14B using K-means clustering to identify transaction clusters on a per-material basis that are anomalous by virtue of unit price and quantity (122). According to step 122, anomaly detector 14B may, on a per material basis, use a two-cluster K-means clustering to divide the material's transaction dataset (obtained from purchasing transaction data 4) by absolute median deviations of log transformed unit price and quantity. The input quantity and price metrics that are processed by the K-means clustering are shown in equations (1) and (2) below:

$$Log - qty - distance = \vert log ( Q ) - \overline{log ( Q )} \vert \qquad ( 1 )$$

$$Log - price - distance = \vert log ( P ) - \overline{log ( P )} \vert \qquad ( 2 )$$

Equations (1) and (2) measure the absolute LOG-10 (logarithm to the base of ten) median deviations of quantity (Q) and unit price (P), respectively. The log transformation described in equations (1) and (2) compresses skewed datasets to a narrower range of values, the median deviation centralizes the data around a median, and the absolute value transforms the representation of the data into distances from the log-transformed median. Anomaly detector 14B uses the K-means clustering to identify two cluster centroids in the two-dimensional plane defined by the two metrics produced by equations (1) and (2).

Anomaly detector 14B may identify a “standard” transaction cluster has a centroid position that is at or nearer to the zero point on the plane than the other cluster, and a “nonstandard” transaction cluster has the more distant centroid position of the two clusters. Anomaly detector 14B may exclude the transactions of the nonstandard cluster from further calculations if anomaly detector 14B determines that the separation between the two centroids is sufficient (e.g., via a thresholding calculation or in another way) (124). Optionally, anomaly detector 14B may recursively repeat the steps 122 and 124 of quantity/price anomaly exclusion phase 126 to identify possible sub-clustering within the remaining transactions.

The price anomaly exclusion phase 132 begins with anomaly detector 14B fitting a piece-wise linear function to unit price history obtained from purchasing transaction data 4 using one or more forecasting tools (128). That is, anomaly detector 14B may execute a forecasting algorithm to identify any price anomalies among the remaining transactions on a per-material basis. In examples in which anomaly detector 14B implements the forecasting algorithm, anomaly detector 14B may use the forecasting algorithm to model each material's unit price history as a piece-wise linear function and to model the unit price uncertainty. One example of a forecasting tool that anomaly detector 14B may use is the Prophet open-source algorithm available from Meta Platforms, Inc. (formerly Facebook® Inc.).

After fitting the model at step 128, anomaly detector 14B may exclude transactions that deviate from an acceptance interval around the fit from further calculations, provided that the number of exclusions are less than a predetermined percentage of the material's dataset size (130). The acceptance interval that anomaly detector may use to detect price anomalies calculated from the uncertainty interval can be adjusted to allow for different levels of detection sensitivity. Optionally, anomaly detector 14B may recursively repeat steps 128 and 130 of price anomaly exclusion phase 132 (e.g., up to a predetermined maximum number of iterations) or until all transactions are within the acceptance interval of the fit.

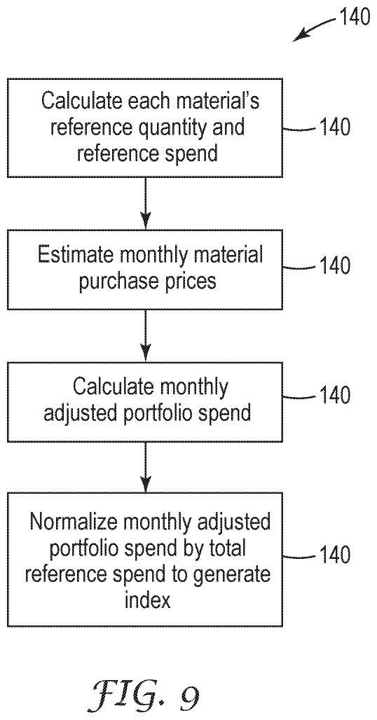

FIG. 9 is a flowchart illustrating process 140 that index constructor 14C may implement to form a PPI according to aspects of this disclosure. For instance, index constructor 14C may use the output of process 104 as corrected by the execution of process 120. Process 140 represents one non-limiting example of an algorithm that index constructor 14C may execute to ingest unflagged transactions associated with the pertinent material/material group selected from portfolio components 6 and transform the unflagged transaction data into a PPI to be stored to internal indices 8. On a per-material or per-group basis (e.g., for each portfolio material ‘i’∈(1, N) where N is an upper bound with respect to portfolio components 6), index constructor 14C may define a reference year Y_{R,i} as the most recent full year with a positive purchase quantity. If index constructor 14C does not identify any prior year with a positive purchase quantity, then index constructor 14C may use the current year (even if it is a partial year at the time of selection) as Y_{R,i}.

Index constructor 14C may calculate a reference quantity and reference spend for each material or group thereof (142). Index constructor 14C may execute equations (3) and (4) below to calculate the reference quantity and reference spend, respectively, for the given material or group:

$${Q}_{i} = \frac{{\sum }_{j = 1}^{n} {q}_{R , j}}{12} \qquad ( 3 )$$

$${S}_{i} = \frac{{\sum }_{j = 1}^{n} {S}_{{Y}_{R} , j}}{12} \qquad ( 4 )$$

The summation operations in the respective numerators of equations (3) and (4) apply over all purchasing transactions for material i in year Y_{R,i}. On a per-material or per-material-group basis (e.g., for material i), index constructor 14C may calculate a quantity-weighted average unit price on a monthly basis (144). In the calculations described below, ‘T’ denotes the interval of time for which monthly estimates of the PPI will be calculated, and ‘M’ denotes a given month.

$${p}_{i , m} = \frac{{\sum }_{j = 1}^{n} {S}_{M , j}}{{\sum }_{j = 1}^{n} {q}_{M , j}} \qquad ( 5 )$$

In equation (5) above, the numerator represents a summation of the spend on material/group i in month M, and the denominator represents a summation of the purchased quantity of material i in month M.

For each material i, calculate the quantity-weighted average unit price for each month M in T with spend data. For months in time period or time interval T without spend data available from purchasing transaction data 4, index constructor 14C may generate an estimate the material unit price to be the unit price (or estimate thereof) of the most recent month for which spend data is available from purchasing transaction data 4. If index constructor 14C does not detect any preceding month with spend data being available from purchasing transaction data 4, then index constructor 14C use the unit price estimate of the first month with spend.

For each month in time period T, index constructor 14C may calculate a monthly adjusted portfolio spend (146). Index constructor 14C may calculate the monthly adjusted portfolio spend (denoted by s_{adj, M}) according to equation (6) below:

$${s}_{adj , M} = ( {p}_{1 , M} … {p}_{N , M} ) x ( \begin{matrix}{Q}_{1} \\ … \\ {Q}_{N}\end{matrix} ) = {p}_{1 , M} {Q}_{1} + … + {p}_{N , M} {Q}_{N} \qquad ( 6 )$$

In turn, index constructor 14C may normalize the monthly adjusted portfolio spend by a sum of the reference spends to generate the PPI (148). That is, index constructor 14C may divide the monthly adjusted portfolio spend time series by the sum of the reference spends. In other examples, index constructor 14C may normalize the monthly adjusted portfolio spend by dividing the adjusted portfolio spend time series by the adjusted spend of a predetermined reference month. In any event, index constructor may designate the normalized adjusted portfolio spend time series as the PPI and save the PPI to internal indices 8.

In the present detailed description of the example embodiments, reference is made to the accompanying drawings, which illustrate specific embodiments in which the invention may be practiced. The illustrated embodiments are not intended to be exhaustive of all embodiments according to the invention. It is to be understood that other embodiments may be utilized, and structural or logical changes may be made without departing from the scope of the present invention. The following detailed description, therefore, is not to be taken in a limiting sense, and the scope of the present invention is defined by the appended claims.

Unless otherwise indicated, all numbers expressing feature sizes, amounts, and physical properties used in the specification and claims are to be understood as being modified in all instances by the term “about” or “approximately” or “substantially.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

It is to be recognized that depending on the example, certain acts or events of any of the methods described herein can be performed in a different sequence, may be added, merged, or left out altogether (e.g., not all described acts or events are necessary for the practice of the method). Moreover, in certain examples, acts or events may be performed concurrently, e.g., through multi-threaded processing, interrupt processing, or multiple processors, rather than sequentially.

The techniques described in this disclosure may be implemented, at least in part, in hardware, software, firmware or any combination thereof. For example, various aspects of the described techniques may be implemented within one or more processors, including one or more microprocessors, CPUs, GPUs, DSPs, application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components or integrated within common or separate hardware or software components.

The techniques described in this disclosure may also be embodied or encoded in a computer-readable medium, such as a computer-readable storage medium, containing instructions. Instructions embedded or encoded in a computer-readable storage medium may cause a programmable processor, or other processor, to perform the method, e.g., when the instructions are executed. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

Various examples have been described. These and other examples are within the scope of the following claims.

1. A system comprising:
a memory configured to store purchasing transaction data for an organization, one or more portfolio components associated with the purchasing transaction data, and one or more external indices; and
processing circuitry communicatively coupled to the memory, the processing circuitry being configured to:
select one or more of the portfolio components stored to the memory to form a candidate portfolio;
determine a reference quantity and a reference spend associated with the candidate portfolio based on portions of the purchasing transaction data stored to the memory that are associated with the one or more portfolio components included in the candidate portfolio;
generate a monthly adjusted portfolio spend for the candidate portfolio;
normalize the monthly adjusted portfolio spend to form an internal index associated with the candidate portfolio; and
store the internal index to the memory; and
an interface configured to output comparative data between the internal index and a corresponding external index selected from the one or more external indices stored to the memory.

2. The system of claim 1, wherein the internal index is a purchase price index associated with the candidate portfolio as procured by the organization, and wherein each of the one or more external indices represent publicly available pricing information associated with the candidate portfolio.

3. The system of claim 1, wherein to normalize the monthly adjusted portfolio spend, the processing circuitry is configured to divide a monthly adjusted spend time series associated with the candidate portfolio by a sum of reference spend values associated with the candidate portfolio.

4. The system of claim 1, wherein to normalize the monthly adjusted portfolio spend, the processing circuitry is configured to divide a monthly adjusted spend time series associated with the candidate portfolio by an adjusted spend associated with the candidate portfolio in a predetermined reference month.

5. The system of claim 1, wherein the processing circuitry is configured to select the external index based on the external index mapping a material or material or material group that matches the candidate portfolio.

6. The system of claim 1, wherein the purchasing transaction data comprises historical purchasing transactions.

7. The system of claim 1, wherein the processing circuitry is further configured to identify an inflection point in the comparative data based on detecting a temporal intersection between an increase in the internal index and an unchanging trend in the external index.

8. The system of claim 1, wherein the processing circuitry is further configured to remove one or more quantity-based anomalies and/or one or more price-based anomalies from the candidate portfolio to form an anomaly-corrected portfolio, and wherein to generate the monthly adjusted portfolio spend for the candidate portfolio, the processing circuitry is configured to generate the monthly adjusted portfolio spend based on the anomaly-corrected portfolio.

9. The system of claim 8, wherein to remove the one or more quantity-based anomalies and/or one or more price-based anomalies, the processing circuitry is configured to:
implement K-means clustering to form a standard transaction cluster and a nonstandard transaction cluster from the portions of the purchasing transaction data stored to the memory that are associated with the one or more portfolio components included in the candidate portfolio; and
remove all transactions of the nonstandard transaction cluster from the candidate portfolio to form the anomaly-corrected portfolio.

10. The system of claim 9, wherein the K-means clustering is a two-cluster K-means clustering, and wherein to implement the K-means clustering to form the standard transaction cluster and the nonstandard transaction cluster, the processing circuitry is configured to determine that the standard cluster has a first centroid position that is nearer to a zero point of a plane of the portions of the purchasing transaction data associated with the one or more portfolio components included in the candidate portfolio as compared to a second centroid position of the nonstandard cluster.

11. The system of claim 8, wherein to remove the one or more price-based anomalies, the processing circuitry is configured to:
fit a piece-wise linear function to unit price history included in the portions of the purchasing transaction data associated with the one or more portfolio components included in the candidate portfolio using one or more forecasting tools; and
remove one or more transactions of the portions of the purchasing transaction data associated with the one or more portfolio components included in the candidate portfolio that deviate from an acceptance interval around the fit.

12. The system of claim 11, wherein the processing circuitry is further configured to remove one or more transactions of the portions of the purchasing transaction data associated with the one or more portfolio components included in the candidate portfolio that deviate from an acceptance interval around the fit based on a determination that the one or more transactions form less than a predetermined percentage of the purchasing transaction data associated with the one or more portfolio components included in the candidate portfolio.

13. A method comprising:
storing, to a memory of a system, purchasing transaction data for an organization, one or more portfolio components associated with the purchasing transaction data, and one or more external indices;
selecting, by processing circuitry of the system, one or more of the portfolio components stored to the memory to form a candidate portfolio;
determining, by the processing circuitry, a reference quantity and a reference spend associated with the candidate portfolio based on portions of the purchasing transaction data that are associated with the one or more portfolio components included in the candidate portfolio;
generating, by the processing circuitry, a monthly adjusted portfolio spend for the candidate portfolio;
normalizing, by the processing circuitry, the monthly adjusted portfolio spend to form an internal index associated with the candidate portfolio; and
storing, by the processing circuitry, the internal index to the memory; and
outputting, by the processing circuitry, via an interface of the system, comparative data between the internal index and a corresponding external index selected from the one or more external indices stored to the memory.

14. (canceled)

15. A non-transitory computer-readable storage medium encoded with instructions that, when executed, cause processing circuitry of a computing device to:
store, to the non-transitory computer-readable storage medium, purchasing transaction data for an organization, one or more portfolio components associated with the purchasing transaction data, and one or more external indices;
select one or more of the portfolio components to form a candidate portfolio;
determine a reference quantity and a reference spend associated with the candidate portfolio based on portions of the purchasing transaction data that are associated with the one or more portfolio components included in the candidate portfolio;
generate a monthly adjusted portfolio spend for the candidate portfolio;
normalize the monthly adjusted portfolio spend to form an internal index associated with the candidate portfolio;
store the internal index to the non-transitory computer-readable storage medium; and
output, via an interface of the computing device, comparative data between the internal index and a corresponding external index selected from the one or more external indices stored to the non-transitory computer-readable storage medium.
